(19) United States
(12) Patent Application Publication
(10) Pub. No.: US 2012/0235918 A1
(43) Pub. Date: Sep. 20, 2012

(54) SOFT KEY HOT SPOT ACTIVATION SYSTEM AND METHOD

(76) Inventors: Brahmandam Kiran, Las Vegas, NV (US); Vijay Kompella, Las Vegas, NV (US); James M. Morrow, Sparks, NV (US); Carmen DiMichele, Sparks, NV (US)

(21) Appl. No.: 13/438,180

(22) Filed: Apr. 3, 2012

Related U.S. Application Data
(63) Continuation of application No. 11/742,429, filed on Apr. 30, 2007.
Application No. 11/742,429 is a continuation-in-part of application No. 11/223,799, filed on Sep. 8, 2005, now abandoned.

(51) Int. Cl. G06F 3/041; G06F 3/02

(52) U.S. Cl. 345/168

(57) ABSTRACT

The device and method of the present invention includes an operating system that operates on an operating system level and one or more software applications that operate at an application level above the operating system level. Applications are configured to, when running at the application level, present at said display one or more display locations each associated with a user input event selection. Soft keys adjacent to said display are configured to be acted upon by a user to generate input signals to the operating system level independent of any one application configured to run at said application level. A control module is configured to receive said input signals from said one or more soft keys, map and transmit said input signals to a corresponding user selected display location of an application running at the application level to provide an application-related input.

### CROSS-REFERENCE TO RELATED APPLICATIONS

This application is a continuation application of U.S. patent application Ser. No. 11/742,429 filed Apr. 30, 2007 and titled “Soft Key Spot Activation System and Method” which is a continuation-in-part of U.S. patent application Ser. No. 11/223,799 filed Sep. 8, 2005, entitled “Player Interaction Systems”, which are hereby incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates generally to player input devices, systems, and methods, and more particularly, to a system and methodology that utilize soft key hot spot activation on a display screen.

### BACKGROUND

Traditionally, gaming machines have been designed for the presenting a game of chance, game of skill, or a combination thereof. Recently, however, casino operators have become aware that by providing additional features in gaming machines, such features may maintain a player's attention at the gaming machines for a longer period of time. For example, secondary displays have been added to gaming machines to provide players with access to gaming-related information, news, and advertisements. The gaming-related information may include, for example, information on sports betting and various betting options relating to sporting events. News and advertisements can also maintain a player's attention by providing the player with access to information, such as, but not limited to, casino attractions, show times, restaurant and hotel specials, and world events.

Additionally, these secondary displays allow casino operators to implement focused promotions and marketing. Accordingly, the focused promotions and marketing presented on these displays may be used to encourage further game play. Thus, a player's desire or need to leave the gaming machine is reduced by providing the player with access to such non-gaming information. This, in turn, increases player wagering by encouraging the player to remain at the gaming machine for longer time periods, thereby increasing casino profits.

In addition to providing players with supplemental information, casino operators also have found that providing interactive access to the above information enhances the player experience. This type of interactivity allows players significantly more flexibility to make use of the above-described information. Accordingly, components such as touch screens have been developed to provide players with an interactive gaming experience. While these system components have been useful, there remains a need for further interactive devices that are easy to use, cost effective, and enhance the player's gaming experience. There also remains a need for interactive devices used in association with an input device, such as a keypad to enhance the player's interactivity with the gaming device and to enhance the flexibility of the player device.

### SUMMARY

Briefly, and in general terms, various embodiments are directed to gaming devices having player interaction systems. The player interaction system provides various types of information and services to a player. For example, the information and services include gaming related information, non-gaming related information, and concierge services. The player is not only provided with this information, but the player is also able to interact and select various services and to obtain additional information. Furthermore, the player's interaction with the system is intuitive and easy to use. Accordingly, the player's gaming experience is enhanced beyond mere playing of the gaming machine.

In one embodiment, the gaming system comprises one or more gaming machines, a display system, a player interface system, and a player tracking system. The display system includes a display screen that provides player interactive information. The player interface system includes a keypad and a secondary input means. The player tracking system is in communication with the display system and the player interface system, and the player tracking system includes a card reader for accepting and reading player cards.

In another embodiment, the gaming system comprises one or more gaming machines having a game display for displaying one or more games, a player interaction system, and a player tracking system. The player interaction system includes a transparent LCD screen or the like. The player interaction system further includes a keypad positioned behind the transparent LCD screen, wherein the keypad is visible through the transparent LCD screen. Moreover, the player tracking system is in communication with the player interaction system, and the player tracking system includes a card reader for accepting and reading player cards.

In addition to gaming machines and gaming systems, methods for enhancing player interaction with a gaming machine are disclosed herein. In one method, the gaming machine obtains player information from the player. The gaming machine then displays player services information or game parameters on a display screen. The gaming machine is provided with keyboard and secondary input means to enable the player to request player services or to modify various game parameters.

In yet another embodiment, a gaming system includes an operating system that operates on an operating system level, and includes one or more applications that operate at an application level above the operating system level. Specifically, the gaming system includes: at least one gaming machine; a display system for presenting player interactive information, wherein the display system includes a display screen; and a player interface system including one or more soft keys. Notably, each soft key is indirectly mapped to associated coordinate-defined point or region (e.g., X-Y coordinate, X-Y-Z coordinate, X₁₋₂-Y₁₋₂ coordinate, X₁₋₂-Y₁₋₂-Z₁₋₂ coordinate, and the like) on the display screen. In this manner, activation of a soft key sends a signal to a program at the operating system level which in turn signals an application at the application level to register an event at the associated coordinate-defined point or region on the display screen.

In another embodiment, a gaming method enables user interface in a gaming system, wherein the gaming system includes an operating system that runs at an operating system level, and wherein the gaming system includes one or more applications that runs at an application level above the operating system level. The method includes: presenting player interactive information on a display system of a gaming machine, wherein the display system includes a display screen; mapping one or more soft keys to associated coordinate-defined point or region on the display screen, wherein activating a soft key sends a signal to a program at the operating system level which in turn signals an application at the application level to register an event at the associated coordinate-defined point or region on the display screen; and receiving user input via one or more of the soft keys.

In still another embodiment, a gaming method again enables user input in a gaming system, wherein the gaming system includes an operating system that runs at an operating system level, and wherein the gaming system includes one or more applications that runs at an application level above the operating system level. The method includes: providing at least one gaming machine, wherein the gaming machine includes a display screen and soft keys indirectly associated with coordinate-defined point or region on the display screen, wherein the soft keys are not directly associated with any application running at the application level; receiving user input via one or more soft keys being activated in a player interface system; generating an interrupt signal that is sent to a control module at the operating system level, in response to a soft key being activated; sending a key code instruction to an application at the application level to register an event on the display screen, in response to an command from the control module at the operating system; generating a signal at the application level to designate a received event at the associated coordinate-defined point or region, in response to received the key code instruction; and recording the received event at the associated coordinate-defined point or region on a display screen.

Other features will become apparent from the following detailed description, taken in conjunction with the accompanying drawings, which illustrate by way of example, the features of the various embodiments.

### BRIEF DESCRIPTION OF THE DRAWING

FIG. 1 is a perspective view of one embodiment of a gaming machine having a player interaction system;

FIG. 2 is a front view of another embodiment of a player interaction system;

FIG. 3 is a front view of another embodiment of a player interaction system;

FIG. 4 is a front view of yet another embodiment of a player interaction system;

FIG. 5A is a plan view of one embodiment of a player interaction system;

FIG. 5B is a plan view of another embodiment of a player interaction system;

FIG. 5C is a plan view of one embodiment of a player interaction system;

FIG. 6 is a front view of yet another embodiment of a player interaction system;

FIG. 7 is a logical flow diagram of the signalling instructions produced by a press of a soft key in one embodiment of a player interaction system; and

FIG. 8 is a front view of another embodiment of a player interaction system using soft keys that are associated with hot-spots on the display screen.

### DETAILED DESCRIPTION

Various embodiments disclosed herein are directed to gaming machines having a player interaction system. The player interaction system generally includes a graphics display, a keypad, a secondary input means, and a card reader. The player interaction system provides a player-friendly interface for a player to obtain gaming and non-gaming information, to control game play, or to control various functions of the gaming machine. Furthermore, the features of the player interaction system may be adapted to or customized by the player. In some embodiments, the player interaction system uses encrypted keypads or other input devices to provide additional levels of security.

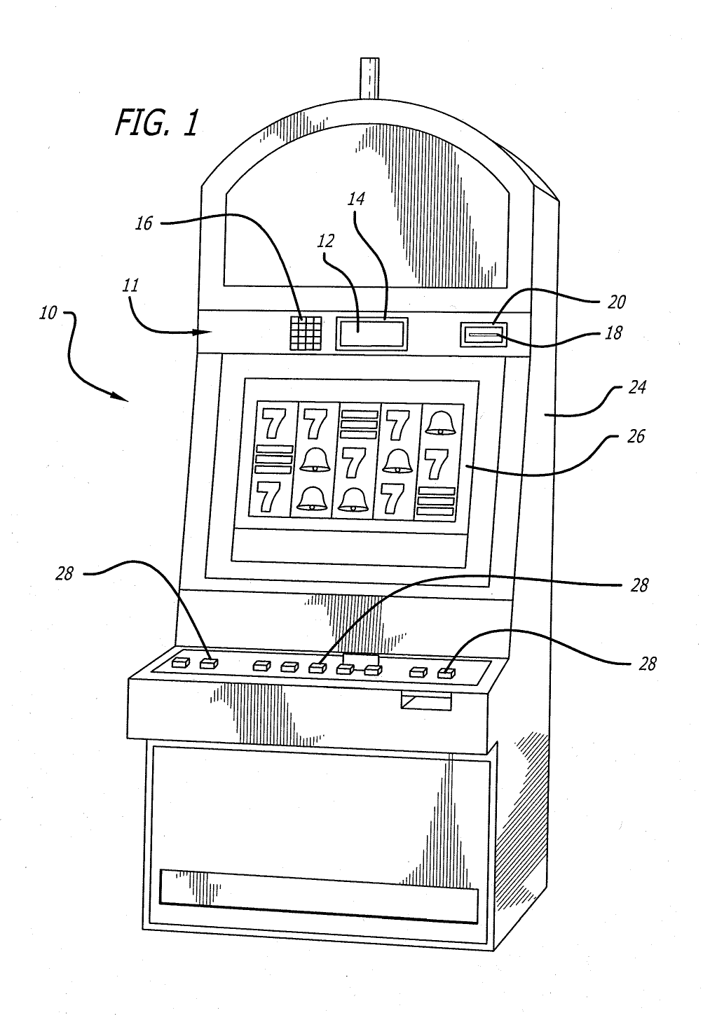

Referring now to the drawings, wherein like reference numerals denote like or corresponding parts throughout the drawings and, more particularly to FIGS. 1-6, there are shown various embodiments of a gaming machine having a player interaction system. Specifically, referring to FIG. 1, the gaming machine 10 includes a cabinet 24, a game display 26, a plurality of player-activated buttons 28, and a player interaction system 11. The cabinet 24 is a self-standing unit that is generally rectangular in shape. In other embodiments, the cabinet (not shown) may be a slant-top, bar-top, or table-top style cabinet. However, any shaped cabinet may be used with any embodiment of the gaming machine 10.

The game display 26 presents one or more games of chance such as, but not limited to, mechanical slots, video slots, video keno, video poker, or Class II bingo. In alternate embodiments, the game display 26 may present games of skill or games of chance involving some player skill In one embodiment, the game display 26 is a CRT or a panel display such as, but not limited to, liquid crystal, plasma, electroluminescent, vacuum fluorescent, field emission, or any other type of panel display known or developed in the art. Additionally, the game display 26 may also include a touch screen or touch glass system (not shown).

As shown in FIG. 1, one embodiment of the player interaction system 11 comprises a graphics display 12, a touch bezel 14, a keypad 16, and a player card reader 18, and a card reader bezel 20. The graphics display 12 may display any visual screen images (e.g., pictures, characters, symbols) and video images that have been converted for compatibility with digital or computer manipulation, transport and storage. The player interaction system 11 is positioned above the game display 26 as shown in FIG. 1. Alternatively, the player interaction system 11 may be positioned below or next to the game display 26 on any other location so desired.

In one embodiment, the graphics display 12 for the player interaction system 11 is generally a panel display such as, but not limited to, liquid crystal, plasma, electroluminescent, vacuum fluorescent, field emission, or any other type of panel display known or developed in the art. In another embodiment, the graphics display 12 is a transparent LCD display. According to one embodiment, the graphics display 12 is a 320×240 display. However, virtually any size or type of display 12 may be used in conjunction with the player interaction system 11.

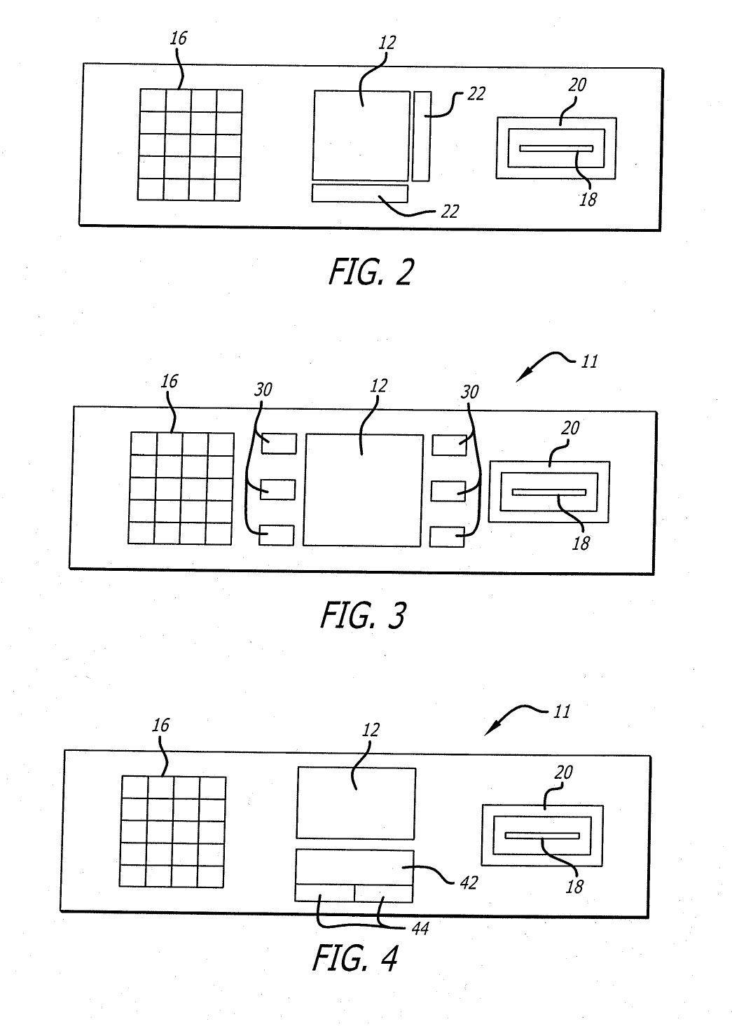

In the embodiment shown in FIG. 1, a touch bezel 14 surrounds the display 12. The touch bezel 14 forms a frame surrounding the display 12 where no portion of the touch bezel contacts the display. As shown in FIG. 1, the touch bezel 14 is a single component, but the touch bezel may be made from one or more touch screen or touch glass components (not shown). For example, one or more touch-activated bars 22 may be positioned around the perimeter of the display 12. As shown in FIG. 2, two touch-activated bars 22 are positioned below and to the right of the display 12. In an alternate embodiment, the touch-activated bars 22 may be positioned on opposite sides of the display 12. As those skilled in the art will appreciate, any number, combination, or positions of the touch-activated bars is contemplated.

The touch bezel 14 and touch-activated bars 22 may use, for example, either touch screen or touch glass technology to receive and interpret player touches. Various touch types may be used to activate the touch bezel 14 and touch-activated bars 22 such as, but not limited to, taps, drags, double taps, or the like. Alternatively, a stylus or other input means may be used to activate the touch bezel 14 or touch-activated bars. The duration and quantity of touches may be used to initiate a function or to make a selection. For example, the touch-activated bars 22 may have a scroll-bar functionality. Accordingly, a player may drag his or her finger along the touch-activated bar 22 to scroll down or across a page on the display 12. Alternatively, the touch bezel 14 or touch-activated bar 22 may be touched or tapped at a particular position to designate a particular selection or function that is presented on the display 12. That is, touching or tapping a particular area on the touch bezel 14 or touch-activated bar 22 activates or selects a particular function or selection presented on the display 12. Accordingly, a player can make a selection or navigate around the display 12 based upon the information presented on the display by touching the appropriate region of the touch-activated bar 22.

Referring back to FIG. 1, the player interaction system 11 includes a keypad 16. The keypad 16 may be configured with a plurality of alphanumeric buttons, numerical buttons, a combination thereof, and the like. The alphanumeric buttons allow a player to input numbers, alphabetical characters, or symbols. The numerical buttons allow a player to only input numbers. In one embodiment, the keypads may have a three dimensional aspect to them that changes in aspect to reflect activation. Additionally, the keypad 16 may include one or more dedicated function buttons. The functions may include enter, clear, cancel, yes, no, forward, or back. In one embodiment, the keypad 16 is a secured keypad. That is, once any data (e.g., PIN number or credit card number) is inputted, the data is encrypted so that all PIN related transactions comply with industry standards for credit card and automated teller machine (ATM) transactions. Accordingly, a player may use an ATM, a debit card, or a credit card, in lieu of cash to play a game on the gaming machine 10. Alternatively, other cashless technology may similarly be used.

A card reader 18 and a card reader bezel 20 are also components of the player interaction system 11. The card reader 18 is generally a device that reads magnetic stripe cards. In this regard, the card reader 18 is used to read player promotional cards, player tracking cards, casino employee cards, smart cards, and the like. Additionally, the card 18 may be configured to also accept and/or read information from a credit card or an ATM card. Generally, the card reader 18 monitors and tracks player and employee activity each time a player or employee inserts his or her card into the reader.

As shown in FIG. 1, a lighted card bezel 20 surrounds the card reader 18. The bezel 20 draws attention to the card reader 18 to visually prompt a player and/or employee to insert and/or remove his card. When a player or employee card is inserted into the card reader 18, the bezel 20 may be illuminated with one or more colors or it may begin flashing. Alternatively, the card reader 18 may not include a lighted card bezel 20. In another embodiment, the player tracking system 11 may include one or more card readers 18. For example, one card reader is dedicated to receiving credit or ATM cards, and the other card reader is adapted to read information from casino-issued player or employee cards.

FIG. 3 illustrates another embodiment of a player interaction system 11 Like previous embodiments, the player interaction system 11 includes a graphics display 12, a keypad 16, card reader 18, card bezel 20, and one or more secondary input means. In the embodiment depicted in FIG. 3, the secondary input means is one or more “soft keys.” Soft keys 30 are multi-functional keys that use a portion of the graphics display 12 to identify each key's function. As shown in FIG. 3, the six soft keys 30 are physical (i.e., not virtual) buttons that are positioned adjacent to the graphics display 12. In other embodiments, the soft keys 30 may be touch-actuated buttons. As those skilled in the art will appreciate, the number and positioning of the soft keys 30 may be varied from the depiction in FIG. 3.

When compared to soft keys that may be positioned directly on the display (not shown), the soft keys 30 shown in FIG. 3 are more durable and able to withstand repeated use. Accordingly, these keys 30 require less maintenance thereby minimizing service-related costs. Furthermore, the soft keys 30 provide design flexibility as each key may have one or more associated functions. For example, the soft keys 30 may have functions, such as, enter, clear, cancel, or continue. The soft keys 30 may be associated with answers, such as “yes,” “no,” or “maybe.” Additionally, the soft keys 30 may have functions that allow a player to navigate between pages shown on the graphics display 12.

Referring now to FIG. 4, another embodiment of a player interaction system 11 is shown. Like previous embodiments, the player interaction system 11 includes a graphics display 12, a keypad 16, card reader 18, card bezel 20, and one or more secondary input means. In this embodiment, the secondary input means is a touchpad 42. As shown in FIG. 4, the touchpad 42 is a generally rectangular pad including one or more buttons 44. In an alternate embodiment, an annular touchpad (not shown) may be provided in association with the player interaction system 11. Alternatively, the touchpad (not shown) may not have any buttons. The touchpad 42 allows a player to navigate around the display 12 with a pointer, scroll through menus, make selections based upon information provided on the display, or to input data. Optionally, the buttons 44 may be used in combination with the touchpad 42 to provide the player with additional means of inputting data.

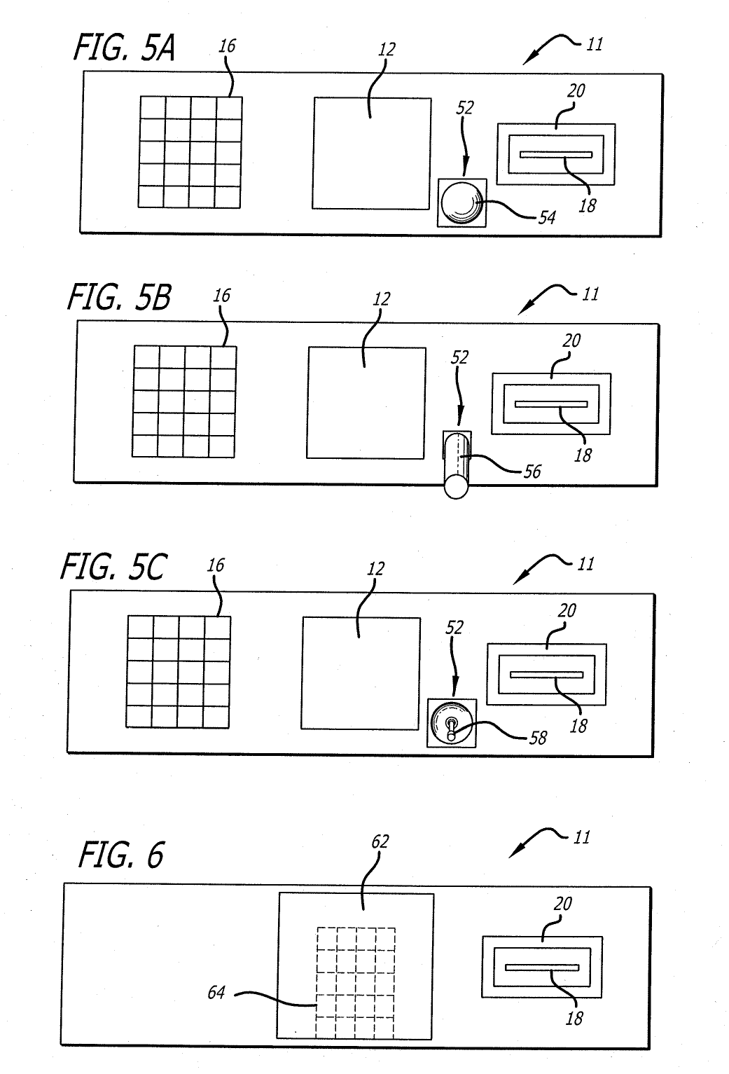

FIGS. 5A-C illustrate other embodiments of a player interaction system 11 using other secondary input devices 52. As shown in FIGS. 5A-5C, the secondary input devices 52 may be a trackball 54, joystick 56, micro-joystick 58, or any other navigation means known or developed in the art. In an alternate embodiment, one or more secondary input devices 52 may be provided in association with the player interaction system 11. The secondary input devices 52 provides a player with the ability to maximize his or her gaming experience by allowing the player to interact with the gaming machine and/or a player services system.

FIG. 6 illustrates still another embodiment of a player interaction system 11 having a transparent LCD screen 62. Additionally, a keypad 64 is positioned behind the transparent LCD screen 62. In one embodiment, the keypad 64 is in direct contact with the LCD screen 62. Alternatively, there may be a small amount of space between the keypad 64 and the LCD screen. In use, when the area on the LCD screen 62 above a particular key of the keypad 64 is touched, the force of the touch is transmitted through the LCD screen 62 to activate the key. That is, the screen 62 has enough flexibility to deflect when depressed to physically contact the key located behind the screen. While the keypad 62 is placed at the bottom of the LCD screen 62 in FIG. 6, the keypad may be placed in any location under the LCD screen. The keypad 62 may have keys for inputting alphanumeric and/or numerical data. In another embodiment, dedicated keys may also be provided with the keypad 62. Additionally, the keypad 62 may be a secured keypad that immediately encrypts the inputted information. In other embodiments (not shown), additional secondary input devices may be included with the player interaction system 11.

In an alternate embodiment, the player interaction system 11, as shown in FIG. 6, may also be used to actually play one or more portions of the game presented on the gaming machine 10. For example, one or more of the keys may be associated with a game play function such as initiating the game, initiating a bonus sequence, or the like. In another embodiment, images displayed on the transparent LCD 62 may be related to the game and prompt the player to depress one or more keys of the keypad 62. The images displayed on the LCD screen 62 may be displayed on the areas adjacent to the keypad 26 or directly over the keypad. In one embodiment, once a player depresses the key, the inputted information is encrypted to minimize tampering with the game.

In another embodiment, the player interaction system (not shown) may include a graphics display, card reader, and one or more secondary input devices. The secondary input devices may be a touch bezel, touch-activated bars, touchpad, trackball, joystick, micro-joystick, or the like. These secondary input devices provide a player with the ability to maximize his or her gaming experience by allowing the player to interact with the gaming machine, a player services system, or play a game provided by the player interaction system.

One of ordinary skill in the art will appreciate that not all gaming machines 10 will have all these components and may have other components in addition to, or in lieu of, those components mentioned here. Furthermore, while these components are viewed and described separately, various components may be integrated into a single unit in some embodiments.

In addition to gaming devices disclosed above, various methods for enhancing player interaction with a gaming device are also provided. In one method, player information is obtained from a player card by reading the information from the card with a card reader 18. The player information may contain a player's name, identification number, gaming habits, player rating, or the like. Other player information stored on a player card may be related to a player's non-gaming preferences and/or interests, such as, but not limited to, shows, favorite restaurants, favorite foods or drinks, or any combination thereof. Additionally, player information stored on a player card may be related to a player's gaming preferences, such as, but not limited to, favorite types of games, speed of game (e.g., fast or slow game play), font size on the game display 26, preferred wager denominations, preferred number of paylines to be played, or a combination thereof. By providing this information on the player card, the gaming machine 10 may be customized to the player's preferences once the player card has been inserted into the card reader 18, thereby enhancing the player's gaming experience.

In another method, in lieu of inserting a player card, player information is inputted into the gaming machine 10 by using the keypad 16 or a secondary input devices such as, but not limited to, the touch bezel 14, touch-activated buttons, touch bar 22, soft keys 30, touchpad 42, annular touchpad, touchpad buttons 44, trackball 52, joystick, micro-joystick, or other input devices known or developed in the art. The player-inputted information may be the player's name, a casino-issued player identification number, a driver's license number or the like. This information may then be transmitted to a host network (e.g., player tracking network (not shown)) to access the player's profile stored on the network. Accordingly, the network may transmit the player's name, player rating, and other preferences to the gaming machine 10.

Once the player information has been received, a prompt or acknowledgement may be displayed on the graphics display 12. For example, the player information such as player name and/or player rating may be displayed on the graphics display 12. The display screen 12 also displays advertisements, player services information, gaming related information, System gaming, and game parameters for the game displayed on the gaming machine 10. For example, player services information may pertain to casino promotions, show times, restaurant choices, or hotel specials. The gaming related information may include, for example, information on sports betting and various betting options for those sporting events. For example, the gaming related information may include information relating to horse racing and/or off-track betting. Alternatively, the information provided on the graphics display 12 may be non-gaming related information, such as, but not limited to, local or world news. System gaming relates to games that may be presented by the player interaction system 11 that are displayed on the graphics display 12. The gaming parameters provided by the player interaction system 11 and presented on the graphics display 12 may include speed of game (e.g., fast or slow game play), font size on the game display 26, wager denomination, number of paylines to be played, or any combination thereof.

In one method, this information is presented on the screen whether or not a player is identified by a player card or player-inputted information. That is, a casino operator may determine a default list of services to be provided via the player interaction system 11. In another method, the player services information and other information displayed on the screen 12 may be accessed or modified when the player accesses a series of menus or answers particular questions when prompted by the player interaction system 11. In another method, the information provided on the display screen 12 is customized according to a player's predetermined preferences.

The various types of information presented on the graphics display 12 may be stored locally in the gaming device 10. Alternatively, the information presented on the graphics display 12 may be stored in a remote location such as a central server. In yet another embodiment, multiple remote sources may store the information presented on the graphics display 12.

Generally, the player services information, gaming related information, non-gaming information, and game parameters displayed on the graphics display 12 are associated with secondary input devices. For example, a soft key 30 may correspond to “game parameter.” Once the player actuates the soft key 30 associated with the “game parameter,” another series of game parameter options appear on the display 12, and these game parameter options are also associated with the soft keys. For example, one soft key 30 may correspond to game instructions. When a player actuates the associated soft key 30, the game instructions, rules, and, optionally, a pay table are displayed on the graphics display 12. In another embodiment, player services information, gaming and non-gaming related information is displayed on the graphics display 12 as links or hyperlinks, and a pointer may be used to select the particular information or service desired. The pointer may be controlled by using a secondary input device such as a trackball, joystick, micro-joystick, trackball, touchpad, or the like.

Accordingly, the player's gaming experience is enhanced by allowing the player to interact with the information provided by the player interaction system 11 on the graphics display 12. The player has the ability to obtain as much additional information as he/she desires. Furthermore, the player is able to interact with the information provided on the player interaction system 11 and to customize the game he/she is playing. Moreover, the player's gaming experience may be enhanced as the player may be able to order a drink, make dinner or show reservations, redeem a coupon, all without leaving the gaming machine 10. Players may also be less fatigued and enjoy their gaming experience more because they can customize various game parameters by inputting their selections using familiar input devices (e.g., the keypad 16 and/or the one or more secondary input devices).

In an alternate embodiment, a cellular phone or other input device (e.g., PDA), separate and apart, from the gaming machine may also be used to input various player choices and information to enhance the player's interactive experience with the gaming system. Furthermore, inputting information via these devices provides an added level of security as any key presses may be hidden from view. In yet another embodiment, a player may call or send a short message service (SMS) to the gaming machine.

While the above embodiments relate to gaming systems, one of ordinary skill in the art will appreciate that the use of a keypad in combination with a secondary input device may find applicability in other non-gaming environments. For example, but not by way of limitation, ATM system, information gathering systems (e.g., wedding registries), may also employ the above-disclosed technology.

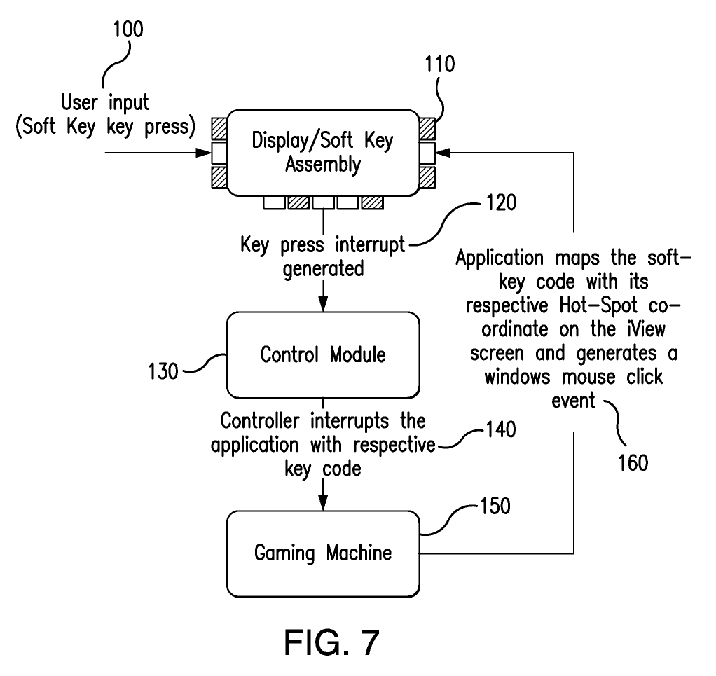

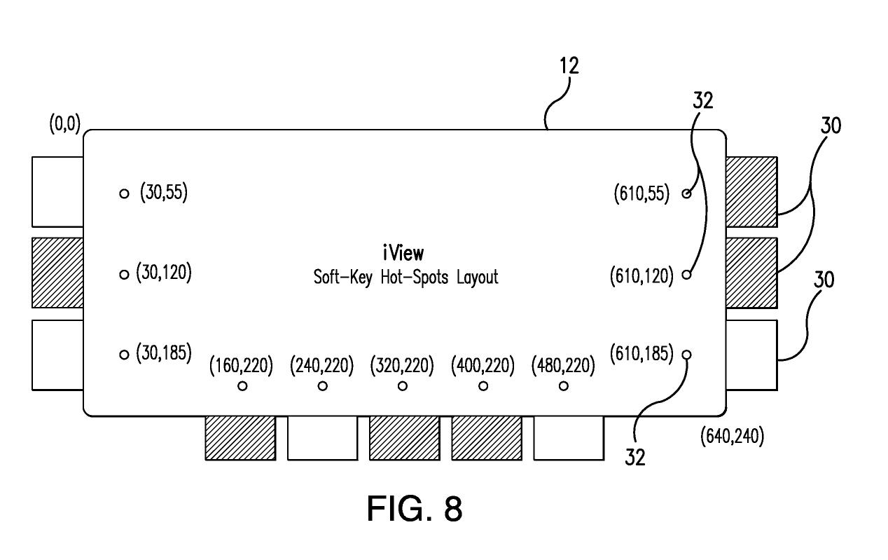

Referring now to FIG. 7, a logical flow diagram illustrating the activation of a key press on the soft keys 30 is shown. As described above, in one embodiment of a player interaction system 11, the display system includes a display screen that presents player interactive information and a player input system that includes a secondary input means. In one embodiment shown in FIG. 8, the secondary input means include soft keys 30 that are mapped to particular coordinate-defined point or region (e.g., X-Y coordinate, X-Y-Z coordinate, X₁₋₂-Y₁₋₂ coordinate, X₁₋₂-Y₁₋₂-Z₁₋₂ coordinate, and the like) on the display screen 12. These coordinate-defined points or regions are referred to as hot spots 32. In this regard, activation (i.e., pressing) of a soft key 30 replicates a mouse “click” or a touch screen “touch event” at the associated hot spot 32. It will be appreciated by one of ordinary skill in the art that the hotspots 32 could be any where on the display screen 12 (including a 2 dimensional or a 3 dimensional display screen). The coordinates are provided by way of example only, and not by way of limitation.

Specifically, FIG. 7 shows a user input 100 (soft key “key press”) of a key in the soft keys 110. The key press 100 generates a key press interrupt 120 that is sent to a soft key control module 130. Next, the control module 130 interrupts the current application (e.g., gaming application, technician maintenance application, or the like) with a respective key code 140 to a gaming machine 150. The current application maps the soft key code with its respective hot-spot coordinate 32 on a display screen 160 (e.g., a traditional gaming display screen, a secondary display screen, a player-tracking user-interface screen (such as an iView screen shown in FIG. 8 and described in U.S. patent application Ser. No. 10/943,771, entitled “User Interface System And Method For A Gaming Machine,” filed Sep. 16, 2004, which is incorporated herein by reference in its entirely), or combinations thereof). In this manner, a mouse “click” or a touch screen “touch event” is recorded at a hot-spot coordinate 32 on a display screen 160 when its respective soft key 30 is pressed.

In one embodiment of a player interaction system 11, the software implementation of the soft-keys 30 is independent of the content (gaming application or otherwise) being displayed. The only implementation requirement is that the navigation targets on the display screen are aligned with the hot-spot coordinates 32 of the soft-keys 30. In regard, when a soft-keys 30 key is pressed, the key generates a mouse click event at its respective hot-spot co-ordinate 32. This architectural configuration saves content developers' time by eliminating the need for writing addition code to support the soft-keys 30. Additionally, this method reduces complexity during content development and makes is very easy to implement (i.e., retrofit) soft-keys on existing content by simply aligning the on-screen button layout so that they have the soft-key hot-spots 32 in the on-screen button regions.

When activated, a soft key 30 press sends a signal to the operating system, rather than to the game being played. The operating system in turn finds the appropriate response to be sent to the game (or other application). The soft keys 30 are compatible with buttons, touch screens, or both. In addition to gaming, soft keys 30 may also be implemented on ticket machines, vending machines, ATMs, car displays, mobile phones, and the like. As described above, each soft key 30 maps a mouse “click” event to an X-Y coordinate 32 or region. In another embodiment, one or more soft keys 30 are mapped to a specific function or a keyboard key. An associated (OS-based) table or database sends the event to the appropriate device, system, or software process.

Soft keys 30 provide additional utility over touch screens and other input techniques that translate into greater player interest and functionality. Specifically, players typically favor the tactile feedback the soft keys often provide over touch screens that may leave a player (or technician) unsure as to whether or not their touch screen “touch” (i.e., event) was registered. Furthermore, soft keys tend to be more intuitive and have defined outer boundaries (i.e., a user typically will not “miss” a button as can occur with touch screens). Moreover, soft keys are significantly less expensive and have far less maintenance issues and associated costs than touch screens. In some embodiments, the soft keys 30 provide a significant amount of tactile feedback, while in other embodiments the tactile feedback provided by the soft keys 30 may be modified for various purposes.

In conclusion, soft-keys 30 can be implemented with existing content and with (little or) no code change at the application level. This operating system-based, soft-key architecture enables content developer to develop content without addition coding to implement soft-keys 30. Specifically, the soft-key architecture simplifies the complexness of the soft-keys 30 implementation by effectively generating what will be received at the application level as a mouse click event at a “hot-spot” coordinate 32.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A device which includes an operating system that operates on an operating system level and one or more software applications that operate at an application level above the operating system level, the device comprising:
a display for presenting application-specific user interactive information, a plurality of applications configured to, when running at the application level, present at said display one or more display locations each associated with a user input selection;
one or more soft keys disposed adjacent to said display and configured to be acted upon by a user to generate input signals to said operating system independent of any one application configured to run at said application level; and
a control module for processing instructions and configured to receive said input signals from said one or more soft keys, map and transmit said input signals to a corresponding user selected display location of an application running at the application level to provide an application-related input.

2. The device of claim 0, wherein a soft key press replicates a mouse click event.

3. The device of claim 0, wherein a soft key press replicates a touch screen touch event.

4. The device of claim 0, wherein a soft key is mapped to a keyboard key via the program at the operating system level.

5. The device of claim 0, wherein said soft keys are a plurality of depressible buttons.

6. The device of claim 0, wherein said soft keys are touch input devices.

7. The device of claim 6, wherein one or more of said touch display input devices are configured to generate input signals corresponding to a dragging motion.

8. A method for providing for a user to interface with a plurality of applications running on an application level in a device having an operating system (OS) configured to run each of said applications at an application level above the level of said OS, said method comprising:
configuring a display to be controlled to display for an application running at said application level locations associated with interfaces to receive user input;
providing soft keys adjacent to said display and configuring one or more of said soft keys to generate an input signal indifferent to any one application configured to run at said application level; and
arranging said OS for receiving said input signals at said operating system level, mapping said input signals to one or more display locations and sending an output signal to said application to register an input event associated with a displayed location.

9. The method of claim 01, wherein activating a soft key sends no direct signal to any application at the application level, but rather signals an application at the application level via the operating system level.

10. The method of claim 8 comprising arranging said OS wherein said mapping and sending of said output signal replicates a mouse click event.

11. The method of claim 8 comprising arranging said OS wherein said mapping and sending of said output signal replicates a touch screen touch event.

12. The method of claim 8 comprising providing said soft keys as one or more touch display input devices.

13. The method of claim 12 comprising configuring one or more of said touch display input device and said OS to receive said input signal responsive to a dragging touch input.
